(19) United States
(12) Patent Application Publication
(10) Pub. No.: US 2011/0119161 A1
(43) Pub. Date: May 19, 2011

(54) AUTOMATED RATINGS OF NEW PRODUCTS AND SERVICES

(76) Inventor: George M. Van Treeck, Alameda, CA (US)

(21) Appl. No.: 12/621,061

(22) Filed: Nov. 18, 2009

(51) Int. Cl. G06Q 30/00; G06F 17/30

(52) U.S. Cl. 705/27.2; 707/709; 707/740; 707/E17.109; 707/E17.046; 707/748

(57) ABSTRACT

A system for automating comparisons and ratings of new product models and services that is timely, efficient, objective and consistent where an expert system extracts model information from a plurality of web page and compares and rates each model against comparable competing models gathered from one or more web sites and stored in a database to be displayed when requested by a user.

### BACKGROUND

The invention pertains to product ratings and more specifically a system for automating comparisons and ratings of new product models and services that is timely, efficient, objective and consistent.

Current magazine and web sites do not provide detailed side-by-side comparisons and ratings of all the latest product models for categories of product where there are many new models produced every few months. Disadvantageously, comparing and rating products, or services, side-by-side is labor intensive and time-consuming. Therefore, these comparisons are not economically feasible to provide. Even when the comparisons and ratings are produced, the time lag between the comparisons and the current models render the comparisons out of date.

For example, currently over one hundred new digital camera models in the $150 USD to $250 USD price band are available from various manufacturers. Each camera product has over 60 features to consider by the average consumer. The number of camera models would require entering more than six thousand camera features into a comparison table. Each of these six thousand camera features need to be assessed and rated specifying how well each camera model's feature compares to the same feature with one or more different camera models.

Additionally, different reviewers and reviewing web sites can create different criteria for the ratings due to each expert's perspective, experience and methods of analysis. Disadvantageously, experts must manually locate and enter data on each model's features into a database, assign a subjective numerical weight indicating the relative importance of each feature, subjectively rate how well each product implements a feature, and subjectively rate how well each product compares overall to other products. This leads to a lack of consistency and objectivity that prevent the average shopper from making an informed opinion of what product or service would meet the shopper's own needs and desires.

Previously, processes, such as, for example, quality function deployment (QFD) have been used because QFD provides matrices where information on competing products is entered along with ratings on the competitors for a feature. A typical example of this is shown in the figures of United States Patent Application Publication No. 2002/0184083 A1 and illustrated in most books about QFD. However, QFD is limited to rating competitors on a single feature at a time for the purpose of defining the design goals of that same feature in a future product and does not rate multiple features on current products. Additionally, United States Patent Application No. 2003/0125980 A1 that describes the use of QFD to decide whether a used product is in the best maintenance condition to facilitate the purchase decision of a “used” product. The method described, however, does not apply to deciding which “new” product to purchase, because deciding that the product has some feature in the best condition is different than deciding that a product or a service has the best designed feature or even if a product or service has that feature.

Also disadvantageously, in a QFD system, the importance weight of each feature is a subjective assignment made by product designers; a rating of how well a feature satisfies a customer benefit is a subjective assignment made by product designers; data acquisition is a manual process (known in QFD as VOC—Voice of the Customer); data entry is a manual process; and no overall scoring of a product (e.g., bad, poor, good, better, best) is performed.

Therefore, there is a need for a system for automating comparisons and ratings of new product models and services that is timely, efficient, objective, and consistent.

### SUMMARY

In one embodiment, there is provided a system for automating comparisons and ratings of new product models and services that is timely, efficient, objective and consistent comprising a web crawler; a database communicatively coupled to the web crawler, where the database comprises rules, stored in the database, that are operable to locate web pages from the web site of a product manufacturer or a service provider that comprises information on models offered; an expert system communicatively coupled to the web crawler and the database, where the expert system extracts model information from a plurality of web page content provided by the web crawler that is compared and rated against comparable competing models gathered from one or more web sites and stores the extracted model information, comparisons, and ratings in the database; a web server-based application communicatively coupled to the database, where the web server-based application transforms the comparisons and ratings stored in the database into reports; and an internet-connected device communicatively coupled to the web server-based application for displaying the extracted information, comparisons, and ratings reports.

In one embodiment, the expert system comprises an administration component; a database communicatively coupled to the administration component; a price band generator component communicatively coupled to the database; a statistics calculator component communicatively coupled to the database; a ratings calculator component; and a rater component that is communicatively coupled to the database, price band generator component, the statistics calculator component and the ratings calculator component.

In one embodiment, the database comprises at least three data tables, where the tables are selected from a table of benefits to the customer, a table of benefit satisfaction ratings and a table of grade definitions. The table of benefit satisfaction ratings comprises a primary key field, a benefit name field that indicates the level of benefit satisfaction, a numeric weight field and a description field that explains the measurable criteria required to use the corresponding rating. The level of benefit satisfaction comprises at least four benefit satisfaction ratings. The benefit satisfaction ratings are selected from the group consisting of high, medium, low and none. The benefit satisfaction ratings comprise a numeric value where the number 7 is a high rating, 3 is a medium rating, 1 is a low rating and 0 is a none rating.

In one embodiment, the at least three database tables are a table of benefits to the customer, a table of benefit satisfaction ratings and a table of grade definitions. The table of benefits to the customer comprises a primary key field, a benefit name field, a numeric benefit weight field, and a benefit description. Each weight field comprises a numeric value. The numeric value is between 1 and 7. The table of benefits to the customer further comprises table rows where the benefit name field of each row comprises a value indicating one or more categories of benefit. The categories of benefit comprises the group selected from a primary purpose of the product, generality/compatibility, usability, reliability, performance, safety, economy, low price, aesthetic and amenity.

In one embodiment, the database further comprises a report table. The report table further comprises one or more row headers; one or more column headers; and one or more table cells, where each table cell is at an intersection of the one or more row headers and the one or more column headers. Each row header comprises a product feature name and the units of measure for that feature. Each column header includes a manufacturer name or service provider name, a brand name, a model name, a price, an overall rating for the named model, and an internet link to a web page to purchase the named model or to a web page containing links to one or more retailers of the named model. Each table cell of the report table has a side-by-side comparison of each model. Each table cell comprises a model feature value and a calculated rating of how the model feature compares to the same or similar features of one or more models. Each of the one or more table cells comprises a model feature value and a rating of the model feature value that are displayed in the ratings report.

In a preferred embodiment, the rating report comprises one or more hypertext links corresponding to each product or service displayed in the ratings report, where the hypertext link links to a web page for purchasing the product or service associated with the rating.

In one embodiment, there is provided a method for automating comparisons and ratings of new product models and services that is timely, efficient, objective and consistent, the method comprising the steps of transmitting instructions from a rater component of the expert system to a price band generator component; separating each model price into a price band for each category of a product or service; storing the price bands in a database; and estimating the relative importance of product and service features by multiplying the identified primary benefit of a feature times the assigned satisfaction level of the benefit based on the measurable satisfaction level criteria to yield a feature's importance weight. The range of each high price band is calculated by the formula: band_high=rounded_up_price(bound*(1+(1/(sqrt(bound)))), where the variable bound is initialized to a highest price of an adjacent lower price band; the function rounded_up_price calculates a value representing the lowest price having all zeros in the least significant digits that is greater than or equal to the input value to the function. The range of each low price band is calculated by the formula: band_low=bound*band_low=bound*overlap_factor, where the variable bound is initialized to a highest price of an adjacent lower price band. In one embodiment, the overlap_factor is between 0.1 and 1.0. In a preferred embodiment, the overlap_factor is 0.8, where the variable bound is initialized to a highest price of an adjacent lower price band.

In one embodiment, the method further comprises the steps of assigning a model into one or more of the price bands associated with the category of a product, a service or both a product and a service using the price of a model and storing the assignments in the database. In a preferred embodiment, the price bands overlap near a boundary of a price band. In a particularly preferred embodiment, the lowest price of a price band overlaps the adjacent lower price band.

In one embodiment, the statistics calculator component calculates the mean value and standard deviation of each model feature of a category in a price band. The rating calculator component calculates a model feature grade on a curve for each model feature in a price band based on the amount and a direction from the mean value of each model feature value and stores the grade in the database.

In another embodiment, the statistics calculator further comprises the steps of multiplying the numeric weight corresponding to the model feature grade times the calculated importance weight of that feature to yield the weighted model feature score; storing the weighted model feature score in the database; summing the weighted model feature scores to yield a raw cumulative model score; storing the raw cumulative model score in the database; calculating the mean value and standard deviation of the raw cumulative model scores in a price band; storing the mean value and standard deviation in the database; calculating an overall grade for each model in a price band, where the statistics calculator calculates an overall grade for a model by grading a raw cumulative model score on a curve; and storing the overall grade in the database.

In a preferred embodiment, the method further comprises the step of calculating comparisons and rankings for each product and service for each category stored in the database. Each rating has a measurable criteria. The measurable criteria is calculated from the formula: X=50/log N and Y=10/log N, where N is the number of features providing some amount of a particular benefit (log base 2); X is a high satisfaction level threshold of a single feature of a product, a service or both a product and a service; Y is a high satisfaction level threshold of a single feature of a product, a service or both a product and a service; and where a level of satisfaction less than Y% and greater than zero is assigned a low satisfaction level, a rating, and a satisfaction level of none for that benefit is assigned where Y% is zero.

In another embodiment, the method further comprises estimating the relative importance of product and service features by multiplying the identified primary benefit of a feature times the assigned satisfaction level of the benefit based on the measurable satisfaction level criteria to yield a feature's importance weight.

In another embodiment, there is provided a method for automating comparisons and ratings of new product models and services that is timely, efficient, objective and consistent, comprising the steps of using regular expression rules to extract from a database brand name, model numbers, model price feature values of models from web pages and stores the extracted information in the database; dividing a range of model prices arranged from highest to lowest into price bands for each model category; assigning a model into at least one price band; grading each model feature in the at least one price band on a curve, storing the grade in a database; multiplying the weight for each model feature with a corresponding assigned benefit multiplied by a weight corresponding to an assigned satisfaction level producing a model feature's importance weight; storing the importance weight in the database; multiplying each model feature of each model in a price band by a numeric weight corresponding to provide a feature grade and multiplying by a calculated importance weight of the feature providing a weighted feature score; storing the weighted model feature score in the database; summing the weighted model feature scores for each model in a price band to provide a raw cumulative model score; storing the raw cumulative model score in the database; calculating an overall grade for each model in a price band by grading the raw cumulative model score on a curve, where the curve is based on the amount and direction of deviation from the mean that compares the model to one or more models in the same price band; storing the overall grade in the database; requesting a model comparison report; transforming the model comparisons and ratings stored in the database into a model comparison and rating report using a program storage device readable by a machine, tangibly embodying a program of instructions executable by a web server-based application; transmitting the model comparison and rating report to a user's internet-connected device; and displaying the transmitted report on the user's internet-connected device. In one embodiment, the product or service data is provided via industry standard protocols. In another embodiment, the product or service data is transferred from data files located on a web server of an internet-connected computer. In one embodiment, the data files are provided in industry standard formats.

In another embodiment, there is provided a method for one or more experts to enter data for automating comparisons and ratings of new product models and services that is timely, efficient, objective and consistent, the method comprising the steps of displaying one or more than one data entry fields for data to be entered into the system; entering data, for each product or service category fields, where the data entry fields comprises names of all the features for that category of product or service, and for each named feature data fields units of measure for that feature, a description of the feature; a name of a primary benefit to a customer selected from the list of customer benefits in a database table; an explanation of how the feature provides the selected benefit; a benefit satisfaction rating selected from the list of benefit satisfaction ratings in a database table; an explanation of the selected benefit satisfaction rating; fields to enter internet URLs and regular expression rules that can be used by a web crawler to locate the models of a product; and fields to enter regular expression rules to extract the model brand name, model numbers, model price, and feature values of product models from web pages product or service; determining if all the entries are complete; storing the entered information in the database; locating web pages containing information on product models using URLs and regular expressions stored in the database to locate the web pages; transmitting the web page content to the rater component of the expert system; and estimating the relative importance of product and service features by multiplying the identified primary benefit of a feature times the assigned satisfaction level of the benefit based on the measurable satisfaction level criteria to yield a feature's importance weight.

### DRAWINGS

These and other features, aspects and advantages of the present invention will become better understood with regard to the following description, appended claims, and accompanying Figures where:

FIG. 1A is a block diagram of a system for automating comparisons and ratings of new product models and services that is timely, efficient, objective and consistent;

FIG. 1B is a detailed block diagram of the expert system of FIG. 1A interfacing with a database;

FIG. 2 is a report table of new product or service comparisons and ratings according to one embodiment of the present invention;

FIG. 3 is a diagram of three database tables of a relational database comprising data for the expert system of FIG. 1 to calculate comparisons and ratings for product and services;

FIG. 4 is a flow chart 400 of some steps of a method for automating comparisons and ratings of new product models and services according to one embodiment of the present invention;

FIG. 5A is a screen shot of a ratings report showing the highest rated product models first according to one embodiment of the present invention;

FIG. 5B is a screen shot of a side-by-side model comparisons report according to one embodiment of the present invention;

FIG. 6 is a flow chart of some steps of a method for an optional manual entry system for the system of FIG. 1;

FIG. 7 is a sample screen shot of a data entry form according to one embodiment of the present invention;

FIG. 8 is a flow chart of some steps of a method useful for generating the price bands for the expert system of FIG. 1; and

FIG. 9 is a listing of some code that is useful for displaying the report of FIGS. 5A and 5B.

### DETAILED DESCRIPTION

This present invention solves the problems with the prior art by replacing the manual and subjective steps of other model comparison methods with an automated, objective process making it economically feasible and timely enough to provide high quality side-by-side comparisons and ratings of all the latest product models and services.

As used in this disclosure, except where the context requires otherwise, the term “comprise” and variations of the term, such as “comprising”, “comprises” and “comprised” are not intended to exclude other additives, modules, integers or steps.

The term “product” refers to a category manufactured product or a service offering, such as, for example: car, television, digital camera, checking accounts, credit cards, etc.

The term “model” refers to a specific instance of a manufactured product or service offering identified by a unique identifier, such as, for example, the product or service name, the product code, the manufacturer's part number, or a service description among others.

The term “expert system” refers to instructions stored in a program storage device readable by a machine, tangibly embodying a program of instructions executable by the machine that simulates the judgment and behavior of a human or an organization that has expert knowledge and experience to extract product information from text, compare and rate products or services. Typically, such a system comprises a knowledge base containing accumulated experience and a set of rules for applying the knowledge base to each particular situation that is described to the program.

The term “relational database” refers to a database that groups data using common attributes found in the data set.

The term “internet-connected device” refers to a device that allows a user's local application to interact with a server-based application through the use of Web services. For example, a smart client running a web browser can interface with a remote server over the Internet in order to view data from the database to be viewed in the web browser.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium can represent one or more devices for storing data, including read-only memory (ROM), random access memory (RAM), magnetic disk storage mediums, optical storage mediums, flash memory devices and/or other computer readable mediums for storing information. The term “computer readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a computer-readable medium such as a storage medium or other storage. A processor may perform the necessary tasks. A code segment may represent a procedure, a function, a subprogram, a program, a routine, a subroutine, a module, a software package, a class, a component, or a combination of instructions, data structures, or program statements. A code segment may be coupled to another code segment or a hardware circuit by passing and/or receiving information, data, arguments, parameters, or memory contents. Information, arguments, parameters, data, etc. can be passed, forwarded, or transmitted through a suitable means including memory sharing, message passing, token passing, network transmission, etc.

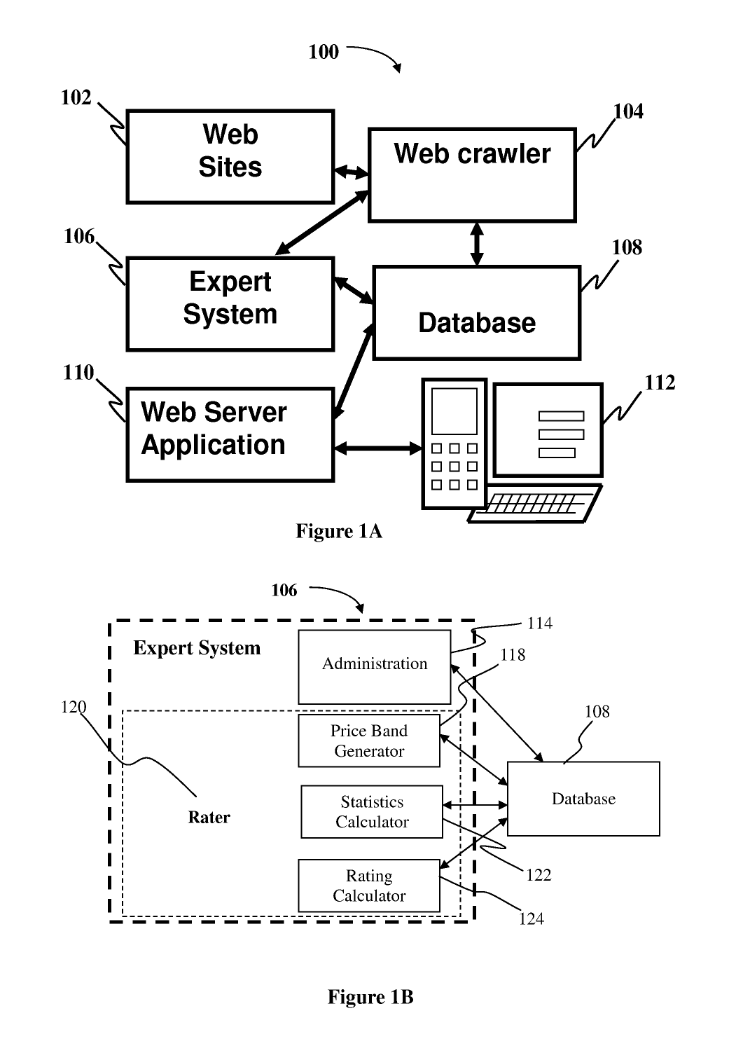

As can be seen in FIG. 1A, there is shown a block diagram 100 of a system for automating comparisons and ratings of new product models and services that is timely, efficient, objective and consistent. The system comprises a web crawler 104 communicatively coupled to a database 108. The database 108 comprises rules, stored in the database 108, that are operable to locate web pages from a web site 102 of a product manufacturer or a service provider that comprises information on models offered. The web crawler 104 transmits the information from the web site 102 to an expert system 106 that is communicatively coupled to the web crawler 104 and the database 108. The expert system 106 extracts model information provided by the web crawler 104 from content located on the web site 102. The model information is compared and rated against comparable competing models gathered from other web sites 102. The expert system 106 stores the extracted model information, comparisons, and ratings in the database 108. A web server-based application 110 is communicatively coupled to the database 108 and transforms the comparisons and ratings stored in the database 108 into reports to be displayed through the Internet on an internet-connected device 112. Smaller internet-connected devices 112, such as, for example, mobile phones can display a linear list of models and their ratings with highest rated models listed first.

Referring now to FIG. 1B there is shown a detailed block diagram of the expert system 106 interfacing with a database 108. The expert system 106 comprises an administration component 114 and rater 120 that are communicatively coupled to a database 108. The database 108 is communicatively coupled to a price band generator component 118, a statistics calculator component 122 and a ratings calculator component 124 of the rater component of the expert system 106. The price band generator component 118, the statistics calculator component 122 and the ratings calculator component 124 are subcomponents of the rater 120.

The rater 120 transmits instructions to the price band generator component 118. For each category of product, the price band generator component 118 separates each of the model prices into price bands (e.g. subranges) and stores the price bands in the database 108. There are many known methods for calculating the number and size of each price band, commonly referred to as cluster analysis, and will be understood by those with skill in the art with reference to this disclosure.

The price band generator component 118 uses the price of a product model in the database 108 and assigns a model into one or more of the price bands associated with the category of product. The price band generator 118 then stores the assignments in the database 108. A model in a lower price band can compete with models in a higher price band. Therefore, price bands can overlap, such that models near the upper boundary of a price band are also assigned to the adjacent higher price band (when a higher price band exists).

The rater 120 transmits instructions to the statistics calculator component 122 to calculate a mean value and standard deviation for each feature of a category of a model in a price band.

The rater 120 also transmits instructions to the rating calculator component 124 to calculate a model feature grade (rating) on a curve for each model feature in a price band based on the amount and direction from the mean value of each model feature value and stores the grade in the database 108. The rating calculator obtains the grade definition and criteria for assigning a grade from a grades table 306. The grade indicates how well or poorly a model's feature value compares to the same feature values of other models. Grading on a curve is a well known method used by teachers to grade test results and by psychologists to rate a person's IQ, etc. Alternative methods of grading on curve can be used. In one embodiment, the alternative method consists of normalizing the scores to the highest score. All scores within some percentage of the highest score, for example, within 90% of the highest score, get the highest grade, etc.

The rater 120 also transmits instructions to the statistics calculator component 122 that multiplies a numeric weight obtained from the grades table 306 corresponding to the model feature grade times the calculated importance weight of that feature to yield the weighted model feature score and stores the weighted model feature score in the database 108 for each feature of each model in a price band.

The rater 120 transmits instructions to the statistics calculator-component 122 to sum the weighted feature scores to yield a raw cumulative model score and stores the raw cumulative model score in the database 108 for each model in a price band. The statistics calculator component 122 then calculates the mean value and standard deviation of the raw cumulative model scores in a price band and stores the mean value and standard deviation in the database 108. Next, the statistics calculator component 122 calculates an overall grade for each model in a price band. The statistics calculator component 122 calculates an overall grade for a model by grading a raw cumulative model score on a curve based on the amount and direction of deviation from the mean of all models or services in a particular price band. The overall grade indicates how a model or service compares to other models or service in the same price band. The statistics calculator component 122 stores the overall grade in the database 108.

Additionally, the system 100 is useful for, but not limited to, comparing and rating competing products and competing services, comparing and rating real estate, contract proposals and design proposals among others.

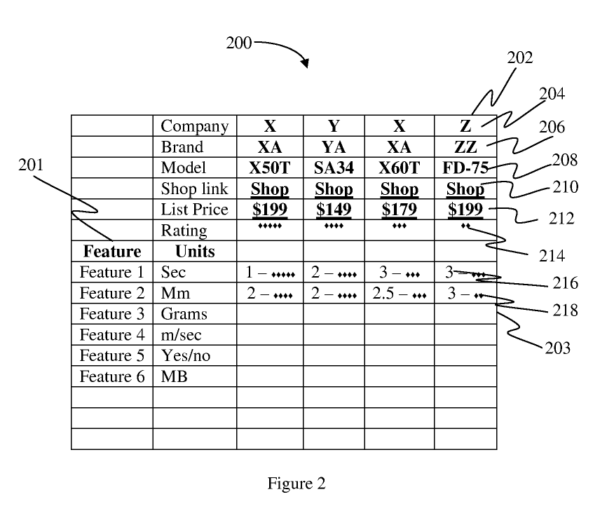

Referring now to FIG. 2 there is shown a report table 200 of new model comparisons and ratings according to one embodiment of the present invention. After the ratings are calculated and stored in the database 108, a web server-based application generates multiple rating reports, such as a side-by-side product comparison shown in the report table 200. The report table 200 comprises one or more row headers 201 and one or more column headers 202. At an intersection of one or more row headers 201 and one or more column headers 202 is one or more table cells 203. Each of the one or more table cells 203 comprises a model feature value 214 and a rating (grade) of a model feature value 216.

Each of the one or more row headers 201 comprises a product feature name and the units of measure for that feature. Each of the one or more column headers 202 includes a manufacturer or service provider name 204, brand name 206, model name 208, model price 212, an overall rating for the named model 208, optionally a buy now or shop link 210, where the model name or buy now or shop link or some other part of the column header 202 functions as an internet link to either a web page where a shopper can immediately purchase the named model or an internet link to a web page to containing internet links to one or more retailers of the named model. Additionally, each column of the report table 200 is sorted so that the highest rated model is displayed first at the top of the report table 200.

Each table cell 203 of the report table 200 is located within each of the comparisons and ratings of new models using the method described herein to assist prospective customers in purchase decisions for new products or services. Each table cell 203 of the report table 200 provides a side-by-side comparison of each product or service model and each table cell 203 comprises a measured attribute 208 of a product or service feature along with a calculated rating 210 of how the model feature compares to the same or similar features of other models.

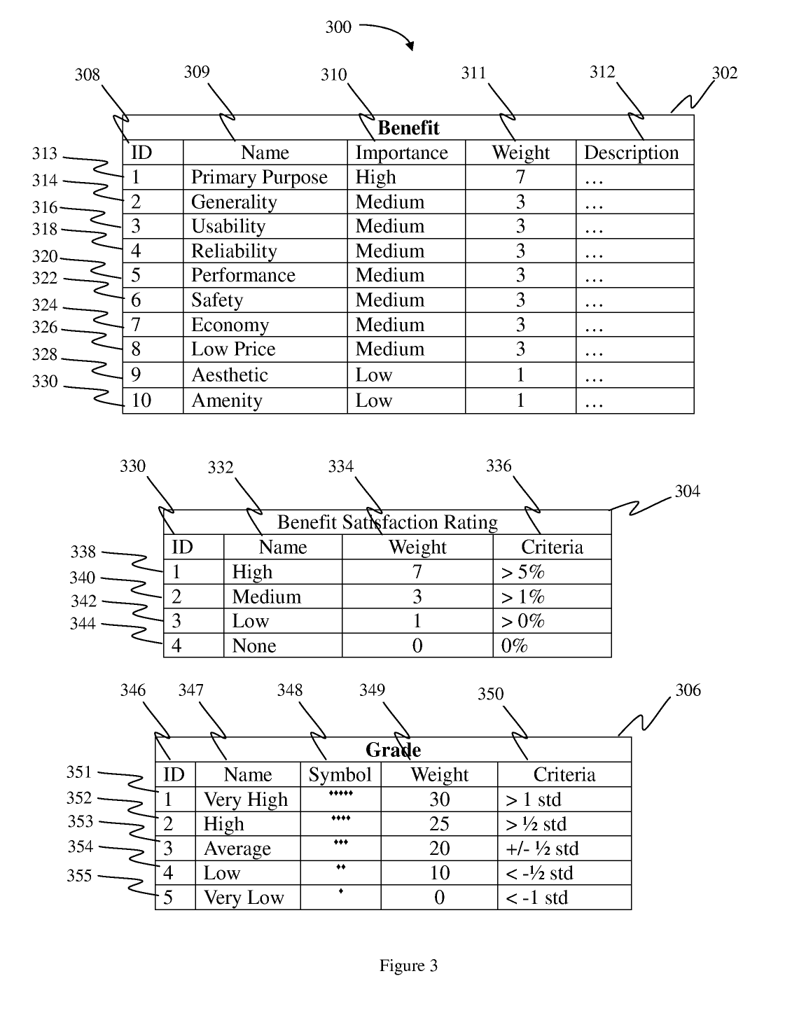

Referring now to FIG. 3, there is shown a diagram of three database tables 300 of a relational database 108 comprising data for an expert system 106 to calculate comparisons and ratings for product and service models. The three database tables 300 comprise a table of benefits to the customer 302, a table of benefit satisfaction ratings 304, and a grades table 306 definitions. The expert system 106 retrieves data from the three database tables 300 and calculates comparisons and rankings for each model for each category stored in the database 108.

In a preferred embodiment, the table of benefits to the customer 302 comprises a primary key field 308, a benefit name field 309, a benefit importance field 310, a numeric benefit weight field 311, and a benefit description field 312. In a particularly preferred embodiment, the table of benefits to the customer 302 also comprises table rows with benefit names indicating the following categories of customer benefit: a primary purpose of the product (high weight) 313, a generality/compatibility (medium weight) 314, a usability (medium weight) 316, a reliability (medium weight) 318, a performance (medium weight) 320, a safety (medium weight) 322, an economy (medium weight) 324, a low price (medium weight) 326, an aesthetic (low weight) field 328, and an amenity (low weight) 330. Each benefit weight field 311 comprises a numeric value of a 7 for a high weight, 3 for a medium weight and a 1 for a low weight. As can be appreciated, other categories and different weightings for each customer benefit and each benefit satisfaction rating can be used.

Each rating in the table of benefit satisfaction ratings 304 indicates how much a feature satisfies a benefit to the customer. Each row of the table of benefit satisfaction ratings 304 comprises a numeric primary key field 330, a rating name field 332 that indicates the level of benefit satisfaction, a numeric weight field 334, and a description field 336 that explains the measurable criteria required to use the corresponding rating. Preferably, four benefit satisfaction ratings of high 338, medium 340, low 342, and none 344 are provided that correspond to a numeric weight of 7 for a high rating 338, 3 for a medium rating 340, 1 for a low rating 342 and a 0 for a no or a none rating 344. As can be appreciated, other weights associated with the ratings can be used.

Both the benefits to the customer 302 and the benefit satisfaction ratings 304 can have a measurable criterion that must be satisfied to get a rating of high or medium. The high benefit satisfaction rating 338 requires that a single feature can be measured to satisfy at least X% of a benefit category, that is, X is the high satisfaction level threshold. A medium rating requires that a single feature can be measured to satisfy at least Y% of a benefit satisfaction rating medium 340, that is, Y is the medium satisfaction level threshold. If the level of satisfaction is less than Y% and greater than zero, then the feature is assigned a low satisfaction rating 342. Otherwise, a rating of none 344, or no relevance to that benefit, is assigned. Preferably, the values X and Y are calculated from equations. Examples of such equations are: X=50/log N and Y=10/log N, where N is the number of features providing some amount of a particular benefit (log base 2).

A more objective and consistent method of estimating the relative importance of product and service features is achieved by multiplying the identified primary benefit of a feature times the assigned satisfaction level of the benefit based on the measurable satisfaction level criteria to yield a feature's importance weight. The calculated feature importance weight provides a more objective and consistent means of estimating the relative importance of product and service features than the prior art of an expert making a personal judgment because the calculated importance weight is based on measurable criteria.

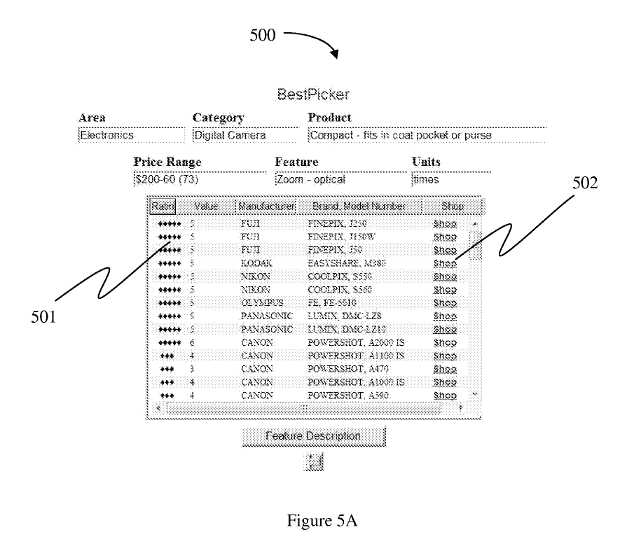

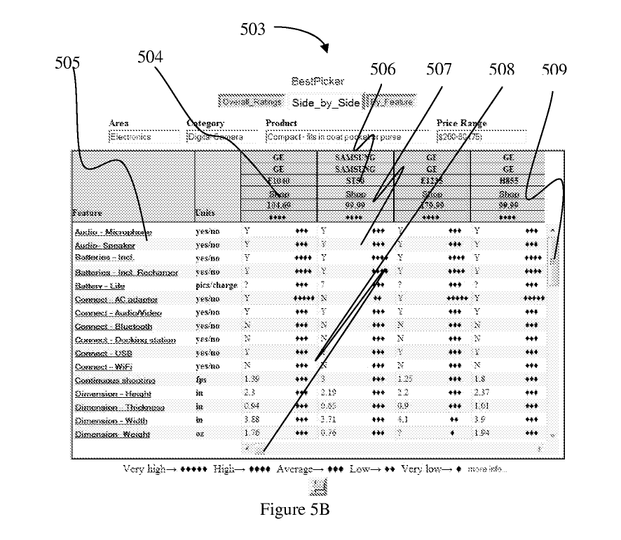

The database 108 comprises a grades table 306 definitions or rating levels indicating how well a product or service compares to other models and how well any given model's feature compares to the same feature on all the other models. Each row of the grades table comprise a primary key field 346, the grade name field 347, a numeric weight field 348 corresponding to the grade name, grade symbol field 349, and a description of the criteria required to get the corresponding grade 350. The preferred embodiment uses five grades: very high, high, average, low, and very low with corresponding symbols and numeric weights. These grades may have corresponding letter symbols, such as, “A, B, C, D, and F”, or graphical symbols 501, such as diamonds, as shown in 201 of FIG. 2, 351-355 of FIG. 3, and of the screen shot in FIG. 5, stars or emoticons (e.g., pictures of faces indicating ecstatic, pleased, indifferent, sad, and angry reactions). Using such symbols is a common practice for product ratings. Additionally, a finer granularity of grades, and corresponding numeric weights, can be used (e.g., B+ or three and half stars). Optionally, the grades and weights can be directly coded into the software of the expert system rather than stored in a database.

First, the expert system 106 then applies regular expression rules to the retrieved information from the web crawler 104 and extracts brand name, model numbers, model price, and feature values of models from the web pages and stores the extracted information in the database 108.

Next, the expert system 106 stores the extracted information into the database 108.

Next, the rater 120 of the expert system 106 retrieves data from the database 108 and calculates ratings for each product model feature and an overall rating of each product model.

Next, the rater 120 of the expert system stores the ratings into the database 108.

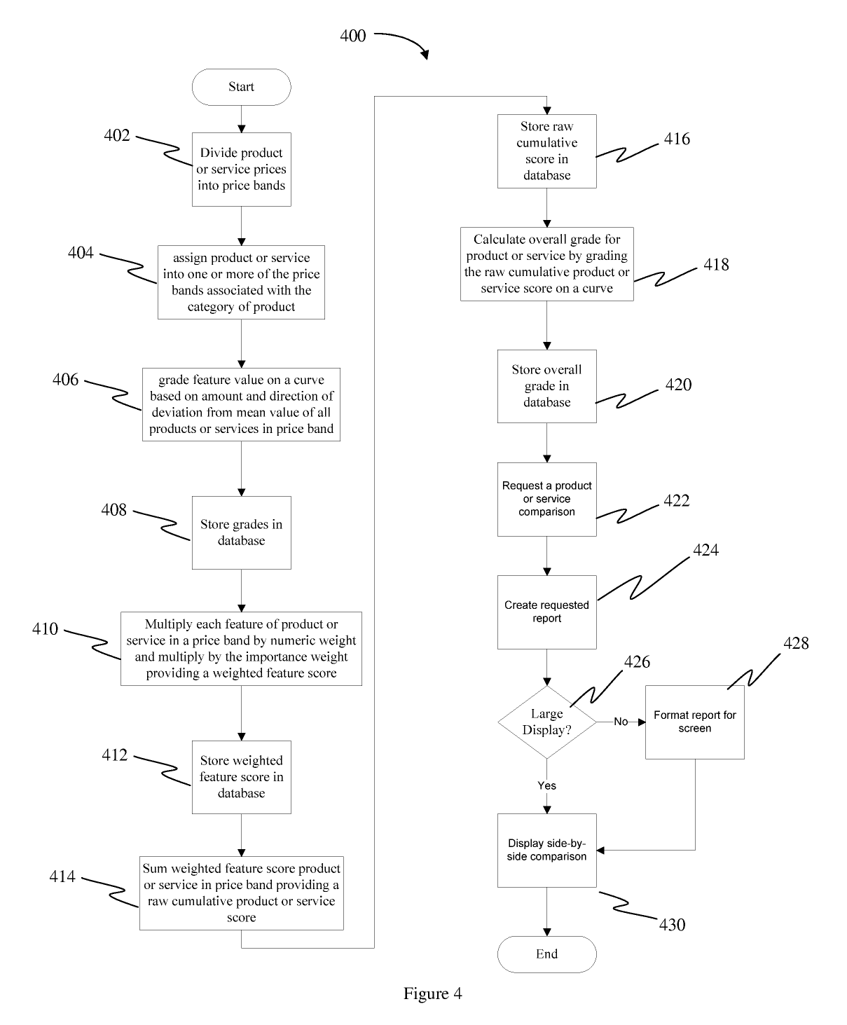

Referring now to FIG. 4, there is shown a flow chart 400 of some steps of a method for automating comparisons and ratings of new product models and services that is timely, efficient, objective and consistent. The steps shown in the flow chart 400 are described in terms of the components shown in the block diagram of FIG. 1.

First, for each category of product, the price band generator component 118 of the expert system 106 reads the prices of each model in the database 108 and divides the range of highest to lowest model prices of each category of product or service into price bands (subranges) 402.

Next, the price band generator component 118 of the expert system 106 assigns each model to at least one price band 404 as previously described and stores the assignments in the database 108.

Then, the statistics calculator component 122 of the expert system 106 calculates the mean value and standard deviation for each feature of a product in a price band.

Next, the rating calculator component 124 of the expert system 106 grades each model feature on a curve based on the distance and direction from the mean value 406 and the ratings are stored 408 in the database 108, where the criteria for the grades table 306 are read from the database 108.

Then, for each model feature, the rating calculator component 124 of the expert system 106 reads the assigned benefit and satisfaction level from the database 108 (database tables 302 and 304) and multiplies the weight corresponding to the assigned benefit times the weight corresponding to the assigned satisfaction level to yield the feature's importance weight and stores 412 the importance weight in the database 108.

Next, for each model feature of each model in a price, the rating calculator component of the expert system 106 reads the numeric weight 410 corresponding to the model feature grade from the database and multiplies the model grade times the calculated importance weight of the feature to yield a weighted model feature score and stores 412 the weighted model feature score in the database 108.

Then, the statistics calculator component 122 of the expert system 106 reads the weighted model feature scores from the database 108 for each model in a price band and sums the weighted model feature scores 414 yielding a raw cumulative model score.

Next, the raw cumulative model score 414 is stored 416 in the database 108.

Then, the rating calculator component 124 of the expert system 106 reads the cumulative model score 416 corresponding to the model feature grade from the database 108 and an overall grade for each model in a price band is calculated 418 by grading the raw cumulative model score on a curve, that is based on the amount and direction of deviation from the mean that compares the model to other models in the same price band.

Next, the overall grade is stored 420 in the database 108.

Then, a user using an internet-connected device 112 requests 422 a product or service model comparison report.

Next, a program storage device readable by a machine, tangibly embodying a program of instructions executable by a web server-based application 110 transforms the model comparisons and ratings stored in the database 108 into a model comparison and rating reports 424.

Optionally, a determination of the screen size of the internet-connected device 112 is made 426 and if the screen is small, the report is formatted to fit the screen 428 of the device 112.

Finally, the product comparison and rating report is transmitted to the user's internet-connected device 112 and displayed 430.

Preferably, the one or more than one data entry fields are fields in a web page created from the HTML elements well known to software developers. Other methods of data entry are also envisioned, such as displaying fields and selections using Adobe® Flash®, Java® applets, and other client-side software that is capable of running within a standards compliant internet web browser or as a software application that runs on a computer and directly loads entered data into the database over a network.

Next, for each feature of a category of product entered by the expert, the system multiplies the corresponding weight of the selected benefit of the feature times the corresponding weight of the selected benefit satisfaction rating to yield a feature importance weight and stores the feature importance weight in the database. The corresponding weights are found by the expert system in a benefits table like those in the benefit table 302, and satisfaction ratings table 304.

For example, if the ease of use metric is the average number of steps to use a product, then an expert can measure the number of steps a feature eliminates to calculate the percentage. Then that percentage can evaluated against the satisfaction rating criteria in the database table 304 to yield a satisfaction rating.

After an expert has entered the above described information on a category of product, a web crawler 104 reads information stored in the database 108 to obtain web pages containing product information and sends those web pages to the expert system 106. Implementing web crawlers that use information in a database to find relevant web pages is a well known art to software developers.

Optionally, data entry forms on the web pages can be used by manufacturers, service providers, and vendors to enter or correct information on product models. Preferably, as an alternative to a web crawler attempting to locate model specifications, manufacturers, service providers and vendors can provide model specifications to the expert system 106 in a fully automated fashion via industry standard protocols such as HTTP POST or simple object access protocol (SOAP). Alternatively, the expert system 106 can obtain product or service specifications by transferring the information from data files located on the web server of an internet-connected computer. The data files can also be provided in industry standard formats, such as, for example, comma separated values (CSV) or XML among others. Optionally, product or service specifications can be provided by data entry forms displayed on web browsers.

FIG. 5A shows a screen shot of a ratings report 500, with the highest rated models listed first. And FIG. 5B shows a screen shot of a side-by-side product comparisons report 503 in a table format, with the highest rated models listed first. After all the ratings are calculated, the web server-based application 110 provides rating reports derived from the data stored in the database 108. An active internet link 502/504 corresponding to each product or service displayed in a ratings report 500/503 links, where the link is to a web page for purchasing a product model or links to a web page listing retailers of the product model.

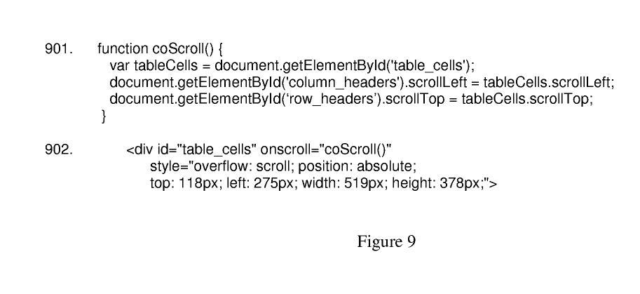

FIG. 5B also describes a novel user interface design providing context-sensitive scrolling, where the context specified by the choice of scroll bar (vertical or horizontal scroll bar) determines which parts of a table get scrolled. The preferred implementation is shown in FIG. 9 by using the “onscroll” event on an HTML “div” element 902 containing an HTML table as displayed in 507, where the onscroll event of the div element calls the Javascript function “coScroll” 901 to cause the table row headers containing the names of product features 505 and table cells containing feature values 507 to scroll up and down while the table column headers containing product model names 506 remain unmoved when moving the vertical scroll bar 509 and the table column headers containing product model names 506 and table cells containing feature values 507 scroll left and right while the table row headers containing the names of product features 505 remain unmoved when moving the horizontal scroll bars 508.

In the current art of side-by-side product comparison reports, the table column headers can remain fixed in place or the row headers remain fixed in place when a scroll bar is used. But, they cannot change which one stays fixed in place depending on the choice of horizontal or vertical scroll bar.

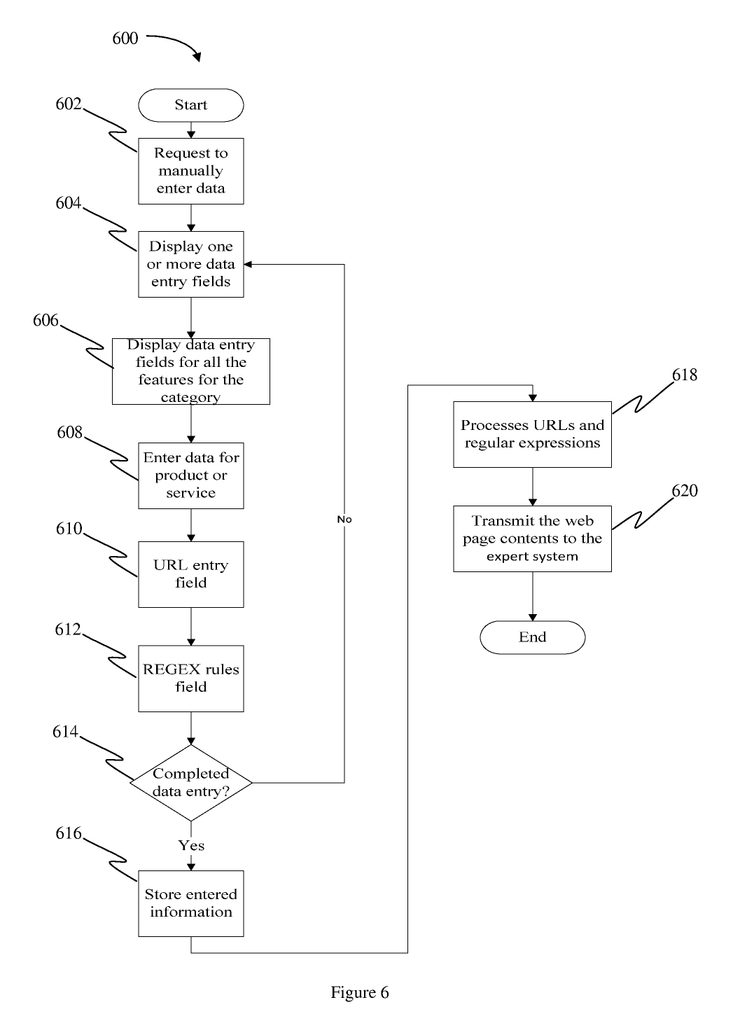

Now referring to FIG. 6 there is shown a flow chart 600 of some steps of a method for the administration component of the expert system 106.

First, an expert requests to manually enter data 602 into the system.

Then, one or more than one data entry fields for data to be entered into the system by an expert are displayed 604 by the administration component of the expert system 106. The one or more than one data entry fields can comprise the name of a product category and brief description of the category among other data fields and are stored in the database 108.

Next, for each product category, the administrative component of the expert system 106 provides data entry fields for one or more experts to enter the names of all the features for that category of product or service are displayed 606, and for each named feature data fields to enter 608, such as, for example, units of measure for that feature, a description of the feature; the name of the primary benefit to the customer selected from the list of customer benefits in a database table 302; an explanation of how the feature provides the selected benefit; the benefit satisfaction rating selected from the list of benefit satisfaction ratings in a database table 304; and a field for the expert to explain the choice of the benefit satisfaction rating.

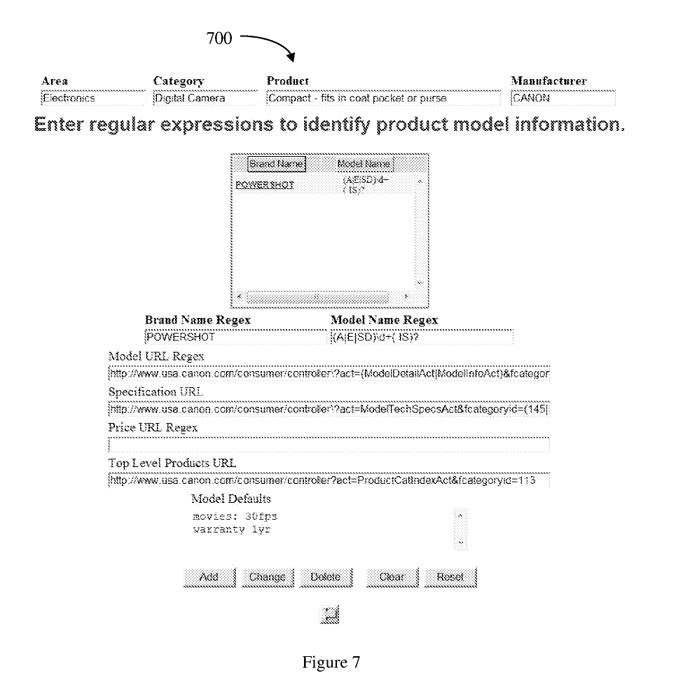

Then, one or more fields to enter an internet Universal Resource Location (URL) 610 and one or more fields to enter regular expression rules 612 that can be used by a web crawler 104 to locate the models of a product; and fields to enter regular expression rules 612 to extract the model brand name, model numbers, model price, and feature values of product models from web pages product or service as shown in the screen shot of FIG. 7.

Next, a determination is made if all the entries are complete 614. Finally, the entered information is stored 616 in the database 108 and processes the information according to the previously describe method.

Then, the web crawler 104 processes URLs and regular expressions 618 stored in the database 108 to locate the web pages containing information on models and transmits 620 the web page content to the expert system 106.

Referring now to FIG. 7, there is shown a sample screen shot 700 of a data entry form according to one embodiment of the present invention.

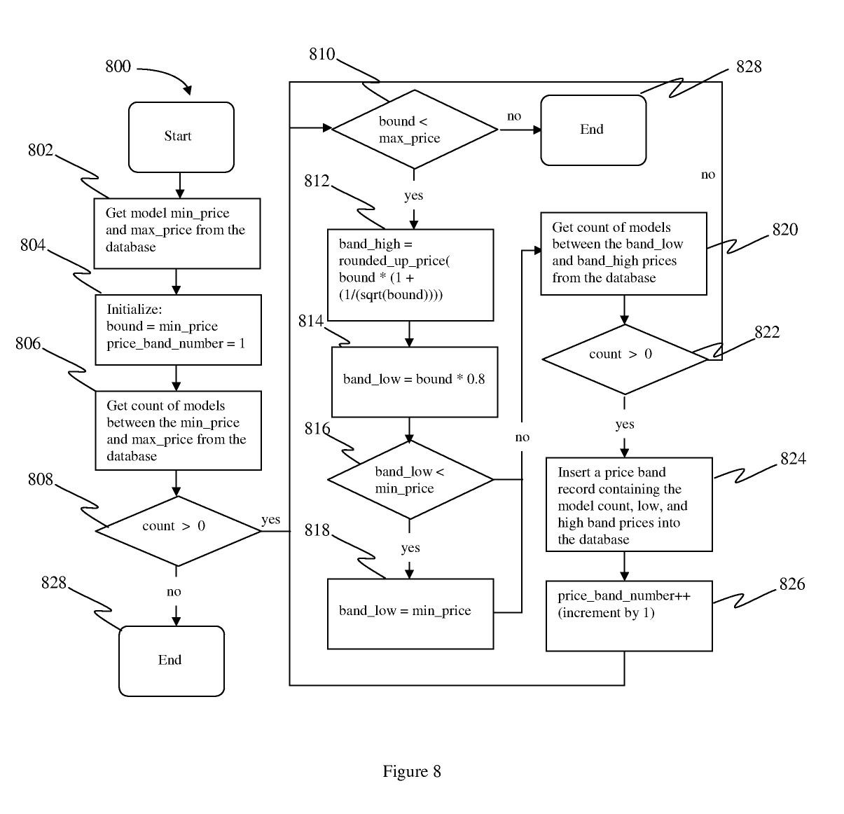

Referring now to FIG. 8, there is shown a flow chart 800 of some steps of a method useful for generating the price bands for the expert system of FIG. 1. First a minimum and a maximum price for a product are retrieved 802 from the database 108. Then an initial minimum price band boundary and a price band number are assigned 804. Next, the number of products in the database 108 that are in the price band are counted 806. If the count is zero 808, then the operation ends 828. Then, if the bound is greater than the maximum price 810, the operation ends 828. Next, in a preferred embodiment, a price band is generated according to equation 1 (eq. 1). Equation 1 calculates the highest price of a price band 812 such that:

band_high=rounded_up_price(bound*(1+(1/(sqrt(price_band_number)))) (eq. 1)

where the variable, bound, is initialized to the highest price of the adjacent lower price band, the variable, price_band_number, indicates the price band starting at the lowest (first) price band, and the function, rounded_up_price, returns the lowest price having all zeros in the least significant digits that is greater than or equal to the input value to the function. Then, a low band is calculated 814 by multiplying the bound by an overlap_factor, where the variable bound is initialized to a highest price of an adjacent lower price band:

band_low=bound*band_low=bound*overlap_factor (eq. 2).

The overlap_factor can be between 0.1 and 1.0. Preferably, the low band is calculated using equation 2 such that the lowest price of a price band such that it overlaps the upper 20% of the adjacent lower price band by setting the overlap_factor equal to 0.8:

Next, if the low band is less than the minimum price 816, then the low band is set to the same value as the minimum price 818. Next, a new count of products between the low band and the high band prices is calculated 820 from the database 108. Then, if the number of products is less than or equal to zero 822, then the previous steps are repeated. Else, a price band record comprising the model count, the low band price and the high band price are inserted 824 into the database 108. Finally the price band number is incremented 826 and the previous steps are repeated.

Equations 1 and 2 provide the variable, price_band_number, and indicates the number of price bands (price sub-ranges). However, other methods of calculating price bands can be used and the equations used above should not be considered limiting for calculating the high and low range of each price band.

Referring now to FIG. 9, there is shown a listing of some code that is useful for displaying the report of FIGS. 5A and 5B. The side-by-side product comparison report displayed as a table in FIGS. 5A and 5B, where table row headers containing the names of product features and table cells containing feature values scroll up and down while the table column headers containing product model names remain unmoved when moving the vertical scroll bar and the table column headers containing product model names and table cells containing feature values scroll left and right while the table row headers containing the names of product features remain unmoved when moving the horizontal scroll bars. One example of code to implement this feature is shown in FIG. 9 using Javascript® and a corresponding Cascading Style Sheet (CSS) layout.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A system for automating comparisons and ratings of new product models and services that is timely, efficient, objective and consistent the system comprising:
a) a web crawler;
b) a database communicatively coupled to the web crawler,
where the database comprises rules, stored in the database, that are operable to locate web pages from the web site of a product manufacturer or a service provider that comprises information on models offered;
c) an expert system communicatively coupled to the web crawler and the database,
where the expert system extracts model information from a plurality of web page content provided by the web crawler that is compared and rated against comparable competing models gathered from one or more web sites and stores the extracted model information, comparisons, and ratings in the database;
d) a web server-based application communicatively coupled to the database,
where the web server-based application transforms the comparisons and ratings stored in the database into reports; and
e) an internet-connected device communicatively coupled to the web server-based application for displaying the extracted information, comparisons, and ratings reports.

2. The system of claim 1, where the expert system comprises:
a) an administration component;
b) a database communicatively coupled to the administration component;
c) a price band generator component communicatively coupled to the database;
d) a statistics calculator component communicatively coupled to the database;
e) a ratings calculator component; and
f) a rater component that is communicatively coupled to the database, price band generator component, the statistics calculator component and the ratings calculator component.

3. The system of claim 2, where the database comprises at least three data tables.

4. The system of claim 3, where the at least three data tables are selected from the group consisting of a table of benefits to the customer, a table of benefit satisfaction ratings and a table of grade definitions.

5. The system of claim 4, where the table of benefit satisfaction ratings comprises a primary key field, a benefit name field that indicates the level of benefit satisfaction, a numeric weight field and a description field that explains the measurable criteria required to use the corresponding rating.

6. The system of claim 5, where the level of benefit satisfaction comprises at least four benefit satisfaction ratings.

7. The system of claim 6, where the benefit satisfaction ratings are selected from the group consisting of high, medium, low and none.

8. The system of claim 7, where the benefit satisfaction ratings comprise a numeric value where the number 7 is a high rating, 3 is a medium rating, 1 is a low rating and 0 is a none rating.

9. The system of claim 4, where the at least three database tables are a table of benefits to the customer, a table of benefit satisfaction ratings and a table of grade definitions.

10. The system of claim 9, where the table of benefits to the customer comprises a primary key field, a benefit name field, a numeric benefit weight field, and a benefit description field.

11. The system of claim 10, where each weight field comprises a numeric value.

12. The system of claim 11, where the numeric value is between 1 and 7.

13. The system of claim 10, where the table of benefits to the customer further comprises table rows where the benefit name field of each row comprises a value indicating one or more categories of benefit.

14. The system of claim 13, where the categories of benefit comprises the group selected from a primary purpose of the product, generality/compatibility, usability, reliability, performance, safety, economy, low price, aesthetic and amenity.

15. The system of claim 1, where the database further comprises a report table.

16. The system of claim 15, where the report table further comprises:
a) one or more row headers;
b) one or more column headers; and
c) one or more table cells, where each table cell is at an intersection of the one or more row header and the one or more column header.

17. The system of claim 16, where each row header comprises a product feature name and the units of measure for that feature.

18. The system of claim 16, where each column header includes a manufacturer name or service provider name, a brand name, a model name, a price, an overall rating for the named model, and an internet link to a web page to purchase the named model or to a web page containing links to one or more retailers of the named model.

19. The system of claim 16, where each table cell of the report table has a side-by-side comparison of each model.

20. The system of claim 16, where each table cell comprises a model feature value and a calculated rating of how the model feature compares to the same or similar features of one or more models.

21. The system of claim 20, where each of the one or more table cells comprises a model feature value and a rating of the model feature value that are displayed in the ratings report.

22. The system of claim 1, where the ratings report comprises one or more hypertext links corresponding to each product or service displayed in the ratings report, where the hypertext link links to a web page for purchasing the product or service associated with the rating.

23. A method for automating comparisons and ratings of new product models and services that is timely, efficient, objective and consistent, the method comprising the steps of:
a) transmitting instructions from a rater component of the expert system to a price band generator component;
b) separating each model price into a price band for each category of a product or service, where the price band comprises one or more high price bands and one or more low price bands;
c) storing the price bands in a database; and
d) estimating the relative importance of product and service features by multiplying an identified primary benefit of a feature times an assigned satisfaction level of a benefit based on a measurable satisfaction level criteria to yield a feature's importance.

24. The method of claim 23, where the range of each high price band is calculated by the formula:
band_high=rounded_up_price(bound*(1+(1/(sqrt(bound)))),
where the variable bound is initialized to a highest price of an adjacent lower price band; the function rounded_up_price calculates a value representing the lowest price having all zeros in the least significant digits that is greater than or equal to the input value to the function.

25. The method of claim 23, where the range of each low price band is calculated by the formula:
band_low=bound*overlap_factor,
where the variable bound is initialized to a highest price of an adjacent lower price band.

26. The method of claim 25, where the overlap_factor is between 0.1 and 1.0.

27. The method of claim 25, where the overlap_factor is 0.8.

28. The method of claim 23, further comprising the steps of:
a) assigning a model into one or more of the price bands associated with the category of a product, a service or both a product and a service using the price of a model; and
b) storing the assignments in the database.

29. The method of claim 25, where price bands overlap near a boundary of a price band.

30. The method of claim 25, where the lowest price of a price band overlaps the lower price band.

31. The method of claim 23, where the step of separating each model price into a price band for each category of a product or service further comprises calculating the mean value and standard deviation of each model feature of a category in a price band.

32. The method of claim 23, where the step of estimating the relative importance of product and service features further comprises grading on a curve for each model feature in a price band based on an the amount and a direction from the mean value of each model feature value and storing the grade in the database.

33. The method of claim 23, where separating each model price into a price band for each category of a product or service further comprises the steps of:
a) multiplying the numeric weight corresponding to the model feature grade times the calculated importance weight of that feature to yield the weighted model feature score;
b) storing the weighted model feature score in the database;
c) summing the weighted model feature scores to yield a raw cumulative model score;
d) storing the raw cumulative model score in the database;
e) calculating the mean value and standard deviation of the raw cumulative model scores in a price band;
f) storing the mean value and standard deviation in the database;
g) calculating an overall grade for each model in a price band, where the statistics calculator calculates an overall grade for a model by grading a raw cumulative model score on a curve; and
h) storing the overall grade in the database.

34. The method of claim 33, further comprising the step of calculating comparisons and rankings for each product and service for each category stored in the database.

35. The method of claim 34, where each ranking has a measurable criteria.

36. The method of claim 35, where the measurable criteria is calculated from the formula:
X=50/log N and Y=10/log N,
where N is the number of features providing some amount of a particular benefit (log base 2);
X is a high satisfaction level threshold of a single feature of a product, a service or both a product and a service;
Y is a high satisfaction level threshold of a single feature of a product, a service or both a product and a service; and
where a level of satisfaction less than Y% and greater than zero is assigned a low satisfaction level rating and a satisfaction level of none is assigned where Y% is zero.

37. A method of estimating the relative importance of product and service features by multiplying an identified primary benefit of a feature times an assigned satisfaction level of a benefit based on a measurable satisfaction level criteria to yield a feature's importance weight.

38. A method for automating comparisons and ratings of new product models and services that is timely, efficient, objective and consistent, the method comprising the steps of:
a) use of regular expression rules to extract brand name, model numbers, model price feature values of models from web pages and product databases and store the extracted information in a database;
b) dividing a range of model prices arranged from highest to lowest into price bands for each model category;
c) assigning a model into at least one price band;
d) grading each model feature in the at least one price band on a curve,
e) storing the grade in a database;
f) multiplying the weight for each model feature with a corresponding assigned benefit multiplied by a weight corresponding to an assigned satisfaction level producing a model feature's importance weight;
g) storing the importance weight in the database;
h) multiplying each model feature of each model in a price band by a numeric weight corresponding to provide a feature grade and multiplying by a calculated importance weight of the feature providing a weighted feature score;
i) storing the weighted model feature score in the database;
j) summing the weighted model feature scores for each model in a price band providing a raw cumulative model score;
k) storing the raw cumulative model score in the database;
l) calculating an overall grade for each model in a price band by grading the raw cumulative model score on a curve,
where the curve is based on the amount and direction of deviation from the mean that compares the model to one or more models in the same price band;
m) storing the overall grade in the database;
n) estimating the relative importance of product and service features by multiplying an identified primary benefit of a feature times an assigned satisfaction level of a benefit based on a measurable satisfaction level criteria to yield a feature's importance weight;
o) requesting a model comparison report;
p) transforming the model comparisons and ratings stored in the database into a model comparison and rating report using a program storage device readable by a machine, tangibly embodying a program of instructions executable by a web server-based application;
q) transmitting the model comparison and ratings report to a user; and
r) displaying the transmitted report to the user.

39. The method of claim 36, where product or service data is provided via industry standard protocols.

40. The method of claim 36, where product or service data is transferred from data files located on a web server of an internet-connected computer.

41. The method of claim 40, where the data files are provided in industry standard formats.

42. A method for one or more experts to enter data for automating comparisons and ratings of new product models and services that is timely, efficient, objective and consistent, the method comprising the steps of:
a) providing the system of claim 1;
b) displaying one or more than one data entry fields for data to be entered into the system;
c) entering data, for each product or service category fields, where the data entry fields comprises names of all the features for that category of product or service, and for each named feature data fields units of measure for that feature, a description of the feature; a name of a primary benefit to a customer selected from the list of customer benefits in a database table; an explanation of how the feature provides the selected benefit; a benefit satisfaction rating selected from the list of benefit satisfaction ratings in a database table; an explanation of the selected benefit satisfaction rating; fields to enter an internet URLs and regular expression rules that can be used by a web crawler to locate the models of a product; and fields to enter regular expression rules to extract the model brand name, model numbers, model price, and feature values of product models from web pages product or service;
d) determining if all the entries are complete;
e) storing the entered information the database;
f) locating web pages containing information on product models using URLs and regular expressions stored in the database to located the web pages;
g) transmitting the web page content to the rater component of the expert system; and
h) estimating the relative importance of product and service features by multiplying the identified primary benefit of a feature times the assigned satisfaction level of the benefit based on the measurable satisfaction level criteria to yield a feature's importance weight.
